(19) United States
(12) Patent Application Publication
(10) Pub. No.: US 2025/0310181 A1
(43) Pub. Date: Oct. 2, 2025

(54) SYSTEMS AND METHODS FOR PERFORMING DATA COMMUNICATIONS OVER A DATA COMMUNICATIONS BUS

(71) Applicants: Advanced Micro Devices, Inc., Santa Clara, CA (US); ATI Technologies ULC, Markham (CA)

(72) Inventors: David Akselrod, Markham (CA); Todd David Basso, Boxborough, MA (US); Robert Landon Pelt, Austin, TX (US); Alexander J. Branover, Boxborough, MA (US)

(73) Assignees: Advanced Micro Devices, Inc., Santa Clara, CA (US); ATI Technologies ULC, Markham (CA)

(21) Appl. No.: 18/622,725

(22) Filed: Mar. 29, 2024

(51) Int. Cl. H04L 41/0663; H04L 12/40; H04L 69/22

(52) U.S. Cl. CPC H04L 41/0663; H04L 69/22; H04L 12/40

(57) ABSTRACT

A method for performing data communication over a data communications bus can include detecting, by at least one processor, a failure of at least one communications channel of two or more communications channels of a data communications bus based at least in part on a header verification code included in a header of a first packet that was communicated over the two or more communications channels. The method can also include performing, by the at least one processor, data communication of a second packet over a subset of the two or more communications channels that excludes the at least one communications channel based on the failure of the at least one communications channel. Various other methods and systems are also disclosed.

### BACKGROUND

A data communications bus is a communication system that transfers data between components inside a computer or between computers. This expression covers all related hardware components (e.g., wire, optical fiber, etc.) and software, including communication protocols. Early computer buses were parallel electrical wires with multiple hardware connections, but the term is now used for any physical arrangement that provides the same logical function as a parallel electrical busbar. Modern computer buses can use both parallel and bit serial connections and can be wired in either a multidrop (electrical parallel) or daisy chain topology, or connected by switched hubs, as in the case of Universal Serial Bus (USB).

A vehicle bus is a specialized internal communications network that interconnects components inside a vehicle (e.g., automobile, bus, train, industrial or agricultural vehicle, ship, or aircraft). Special requirements for vehicle control, such as assurance of message delivery, non-conflicting messages, minimum time of delivery, low cost, and EMF noise resilience, as well as redundant routing and other necessary characteristics in a vehicular environment, can necessitate the use of less common networking protocols. Such protocols can include Controller Area Network (CAN) protocols, Local Interconnect Network (LIN) protocols, and various other protocols. For example, conventional computer networking technologies (e.g., Ethernet, TCP/IP, etc.) can be used in aircraft (e.g., Avionics Full-Duplex Switched Ethernet (AFDX)) and in trains (e.g., Ethernet Consist Network (ECN)).

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for performing data communications over a data communications bus.

FIG. 2 is a flow diagram of an example method for performing data communications over a data communications bus.

FIG. 3 is a block diagram of an example system for performing data communications over a data communications bus.

FIG. 4 is a flow diagram of an example method for performing data communications over a data communications bus.

FIG. 5A is a block diagram of an example system for performing data communications over a data communications bus.

FIG. 5B is a graphical illustration of example communications channels of a data communications bus.

FIG. 6 is a graphical illustration of example subsets of communications channels of a data communications bus.

FIG. 7 is a graphical illustration of example subsets of communications channels of a data communications bus.

FIG. 8 is a graphical illustration of example subsets of communications channels of a data communications bus.

FIG. 9 is a flow diagram of example methods for performing data communications over a data communications bus.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for performing data communications over a data communications bus. For example, by detecting a failure of at least one communications channel of two or more communications channels of a data communications bus based at least in part on a header verification code included in a header of a first packet that was communicated over the two or more communications channels and performing data communication of a second packet over a subset of the two or more communications channels that excludes the at least one communications channel based on the failure of the at least one communications channel, the disclosed systems and methods can achieve various benefits. Example benefits include on-the-fly restoration of failed communications channels, maximization of communication channels up-time, increased fault tolerance, achievement of qualification for safety-critical applications such as automotive requirements, achievement of affective handling of transient and/or permanent physical faults, and achievement of an enhanced resilience appraisal scale level.

The disclosed systems and methods solve numerous problems relating to data communications buses for safety-critical applications. For example, failed communication channels can cause failure of chips and systems containing them as well as decreased communication channels up-time as a result of such failures. Additionally, communication channel failures can result in replacement costs and various associated consequences, such as loss of client data and/or loss of functionality. Also, communication channel failures can cause decreased fault tolerance of devices and prevent qualification of such devices for safety-critical applications, such as automotive requirements. Further, communication channel failures can result in an inability to address permanent physical faults, an inability to address transient channel faults without requiring a retraining process, and/or a decreased resilience appraisal scale level.

Previous efforts to address these problems have suffered from various issues. For example, Link Width re-Negotiation (LWN) can sometimes be an option for addressing these problems. In this context, some devices (e.g., PCIe devices) can negotiate at startup with a switch to determine the maximum number of lanes of which a link can consist. This link width negotiation can depend on the maximum width of the link itself (i.e., the actual number of physical signal pairs of which the link consists), on the width of the connector into which the device is plugged, the width of the device itself, and/or the width of the switch's interface. Renegotiation of this link width is one option that can potentially address some communication channel failures. However, such available channel error containment techniques can prove unsuitable for various reasons. For example, LWN can be unavailable, can be unaffordable (e.g., due to retraining time delay), can fail (e.g., due to failure of an existing LWN to support a particular case of faulty lanes), and/or can be unavailable for a particular protocol or interface.

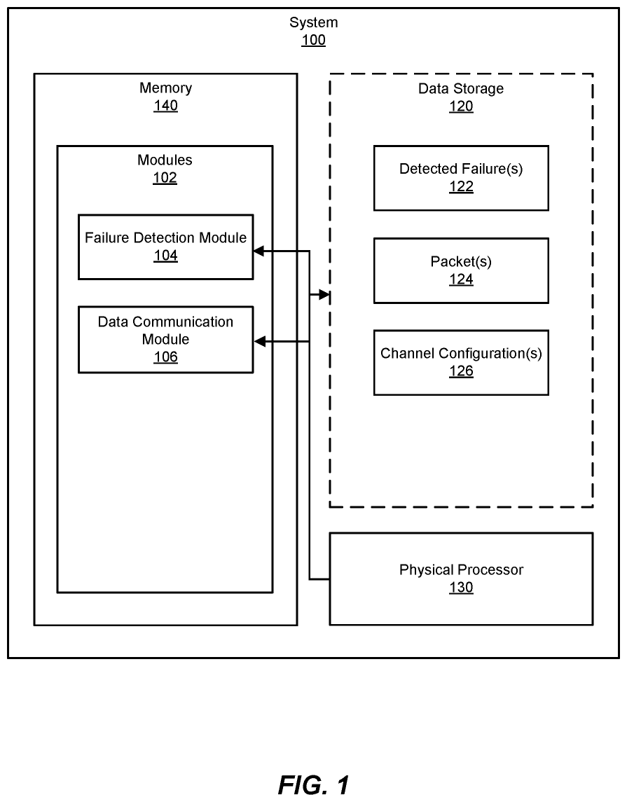

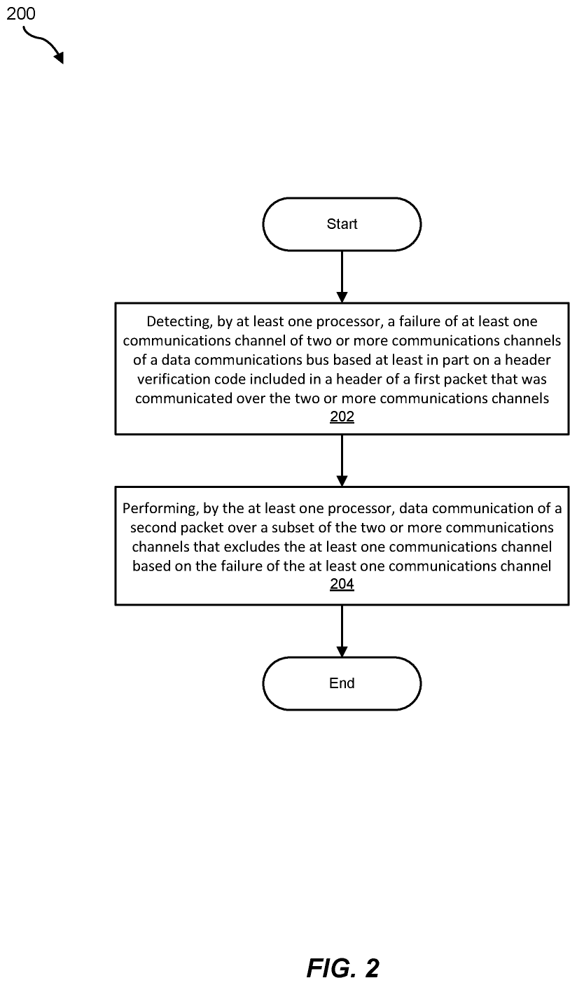

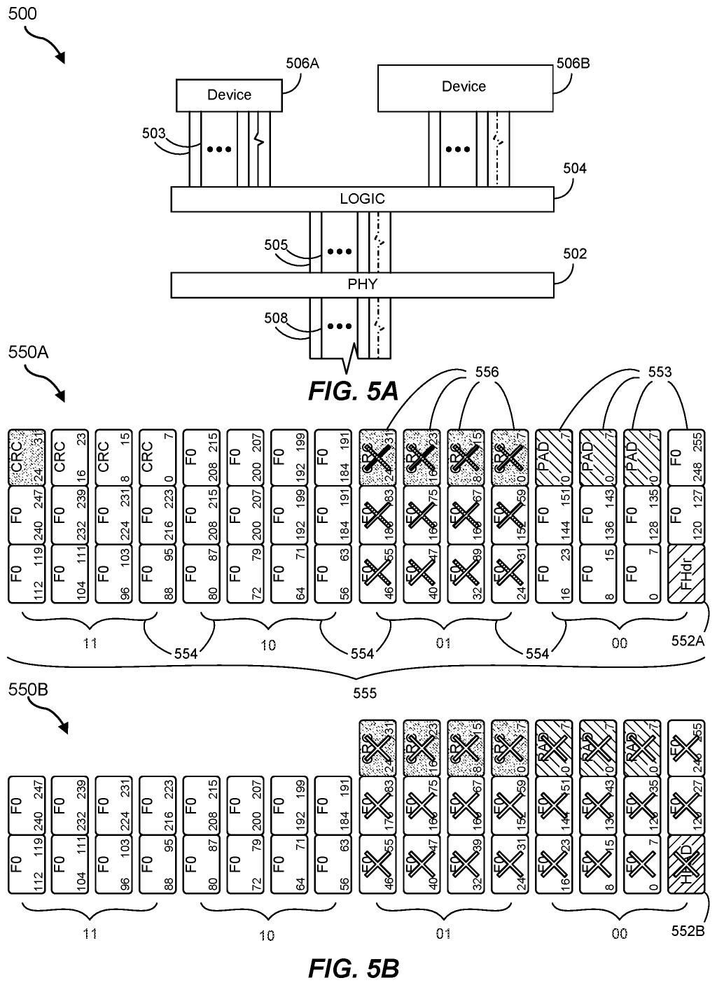

The following will provide, with reference to FIGS. 1, 3, and 5A, detailed descriptions of example systems for performing data communications over a data communications bus. Detailed descriptions of corresponding computer-implemented methods will also be provided in connection with FIGS. 2, 4, and 8. In addition, detailed descriptions of example communications channels and subsets thereof will be provided in connection with FIGS. 5B, 6, and 7.

In one example, a computing device can include failure detection circuitry configured to detect a failure of at least one communications channel of two or more communications channels of a data communications bus based at least in part on a header verification code included in a header of a first packet that was communicated over the two or more communications channels, and data communication circuitry to perform data communication of a second packet over a subset of the two or more communications channels that excludes the at least one communications channel based on the failure of the at least one communications channel.

Another example can be the previously described example computing device, wherein the data communication circuitry is configured to perform the data communication by excluding from the subset of the two or more communications channels, in response to detecting a failure to verify the header of the first packet based on the header verification code, a particular communication channel over which communication of the header of the first packet occurred.

Another example can be any of the previously described example computing devices, wherein the data communication circuitry is configured to perform the data communication by including in a header of the second packet a second header verification code generated from a header of the second packet but not a payload of the second packet, and dynamically reallocating the header of the second packet to a preset location among the two or more communications channels.

Another example can be any of the previously described example computing devices, wherein the data communication circuitry is configured to perform the data communication by excluding from the subset of the two or more communications channels, in response to detecting verification of the header of the first packet based on the header verification code and detecting failure to verify a payload of the first packet, a particular communication channel over which communication of at least part of the payload of the first packet occurred.

Another example can be any of the previously described example computing devices, wherein the data communication circuitry is configured to perform the data communication by performing, in response to detecting verification of a header of the second packet and verification of a payload of the second packet, data communication of a third packet over the subset of the two or more communications channels.

Another example can be any of the previously described example computing devices, wherein the data communication circuitry is further configured to provision one or more spare lanes including one or more unallocated communications channels of the two or more communications channels and allocate at least one of the one or more unallocated communications channels to the subset of the two or more communications channels.

Another example can be any of the previously described example computing devices, wherein the data communication circuitry is configured to perform the data communication by omitting from a payload of the second packet one or more parts of a payload of the first packet, wherein the one or more parts omitted from the payload of the second packet correspond to one or more communication channels excluded from the subset of the two or more communications channels, including in a header of the second packet an indication of the one or more parts omitted from the payload of the second packet, an additional indication of a length of the second packet, and a second header verification code generated from the header of the second packet but not the payload of the second packet, and including in the second packet a packet verification code generated from at least the payload of the second packet.

In one example, a system can include a data communication bus including two or more communications channels, a first device connected to the data communication bus and configured to detect a failure of at least one communications channel of the two or more communications channels based at least in part on a header verification code included in a header of a first packet that was communicated over the two or more communications channels, and a second device connected to the data communication bus, wherein the first device is configured to perform data communication of a second packet to the second device over a subset of the two or more communications channels that excludes the at least one communications channel based on the failure of the at least one communications channel.

Another example can be the previously described example system, wherein the first device is configured to perform the data communication by excluding from the subset of the two or more communications channels, in response to detecting a failure to verify the header of the first packet based on the header verification code, a particular communication channel over which communication of the header of the first packet occurred.

Another example can be any of the previously described example systems, wherein the first device is configured to perform the data communication by including in a header of the second packet a second header verification code generated from a header of the second packet but not a payload of the second packet, and dynamically reallocating the header of the second packet to a preset location among the two or more communications channels.

Another example can be any of the previously described example systems, wherein the first device is configured to perform the data communication by excluding from the subset of the two or more communications channels, in response to detecting verification of the header of the first packet based on the header verification code and detecting failure to verify a payload of the first packet, a particular communication channel over which communication of at least part of the payload of the first packet occurred.

Another example can be any of the previously described example systems, wherein the first device is configured to perform the data communication by performing, in response to detecting verification of a header of the second packet and verification of a payload of the second packet, data communication of a third packet over the subset of the two or more communications channels.

Another example can be any of the previously described example systems, wherein the first device is further configured to provision one or more spare lanes including one or more unallocated communications channels of the two or more communications channels and allocate at least one of the one or more unallocated communications channels to the subset of the two or more communications channels.

Another example can be any of the previously described example systems, wherein the first device is configured to perform the data communication by omitting from a payload of the second packet one or more parts of a payload of the first packet, wherein the one or more parts omitted from the payload of the second packet correspond to one or more communication channels excluded from the subset of the two or more communications channels, including in a header of the second packet an indication of one or more locations of the one or more parts omitted from the payload of the second packet, an additional indication of a length of the second packet, and a second header verification code generated from a header of the second packet but not the payload of the second packet, and including in the second packet a packet verification code generated from at least the payload of the second packet.

In one example, a computer-implemented method can include detecting, by at least one processor, a failure of at least one communications channel of two or more communications channels of a data communications bus based at least in part on a header verification code included in a header of a first packet that was communicated over the two or more communications channels and performing, by the at least one processor, data communication of a second packet over a subset of the two or more communications channels that excludes the at least one communications channel based on the failure of the at least one communications channel.

Another example can be the previously described computer-implemented method, wherein performing the data communication further includes excluding from the subset of the two or more communications channels, in response to detecting a failure to verify the header of the first packet based on the header verification code, a particular communication channel over which communication of the header of the first packet occurred.

Another example can be any of the previously described computer-implemented methods, wherein performing the data communication further includes including in a header of the second packet a second header verification code generated from a header of the second packet but not a payload of the second packet, and dynamically reallocating the header of the second packet to a preset location among the two or more communications channels.

Another example can be any of the previously described computer-implemented methods, wherein performing the data communication further includes excluding from the subset of the two or more communications channels, in response to detecting verification of the header of the first packet based on the header verification code and detecting failure to verify a payload of the packet, a particular communication channel over which communication of at least part of the payload of the first packet occurred.

Another example can be any of the previously described computer-implemented methods, wherein performing the data communication further includes provisioning one or more spare lanes including one or more unallocated communications channels of the two or more communications channels and allocating at least one of the one or more unallocated communications channels to the subset of the two or more communications channels.

Another example can be any of the previously described computer-implemented methods, wherein performing the data communication includes omitting from a payload of the second packet one or more parts of a payload of the first packet, wherein the one or more parts omitted from the payload of the second packet correspond to one or more communication channels excluded from the subset of the two or more communications channels, including in a header of the second packet an indication of one or more locations of the one or more parts omitted from the payload of the second packet, an additional indication of a length of the second packet, and a second header verification code generated from a header of the second packet but not the payload of the second packet, and including in the second packet a packet verification code generated from at least the payload of the second packet.

FIG. 1 is a block diagram of an example system 100 for performing data communications over a data communications bus. As illustrated in this figure, example system 100 can include one or more modules 102 for performing one or more tasks. As will be explained in greater detail below, modules 102 can include a failure detection module 104 and a data communication module 106. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices. One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate performing data communications over a data communications bus. Examples of physical processor 130 include, without limitation, chiplets, monolithic die, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

The term “modules,” as used herein, can generally refer to one or more functional components of a computing device. For example, and without limitation, a module or modules can correspond to hardware, software, or combinations thereof. In turn, hardware can correspond to analog circuitry, digital circuitry, communication media, or combinations thereof. In some implementations, the modules can be implemented as microcode (e.g., a collection of instructions running on a micro-processor, digital and/or analog circuitry, etc.) and/or one or more firmware in a graphics processing unit. For example, a module can correspond to a GPU, a trusted micro-processor of a GPU, and/or a portion thereof (e.g., circuitry (e.g., one or more device features sets and/or firmware) of a trusted micro-processor). In this context, hardware can correspond to one or more chiplets and/or one or more monolithic die.

The term “circuitry,” as used herein, can generally refer to a circuit or system of circuits performing a particular function in an electronic device. For example, and without limitation, circuitry can refer to hardware or hardware plus software/firmware, whether by use of a controller, a processor, or a combination thereof.

As illustrated in FIG. 1, example system 100 can also include one or more instances of stored data, such as data storage 120. Data storage 120 generally represents any type or form of stored data, however stored (e.g., signal line transmissions, bit registers, flip flops, software in rewritable memory, configurable hardware states, combinations thereof, etc.). In one example, data storage 120 includes databases, spreadsheets, tables, lists, matrices, trees, or any other type of data structure. Examples of data storage 120 include, without limitation, detected failure(s) 122, packet(s) 124, and/or channel configuration(s) 126.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 2 is a flow diagram of an example computer-implemented method 200 for performing data communications over a data communications bus. The steps shown in FIG. 2 can be performed by any suitable computer-executable code and/or computing system. In one example, each of the steps shown in FIG. 2 can represent an algorithm whose structure includes and/or is represented by multiple sub-steps, examples of which will be provided in greater detail below.

The term “computer-implemented method,” as used herein, can generally refer to a method performed by hardware or a combination of hardware and software. For example, hardware can correspond to analog circuitry, digital circuitry, communication media, or combinations thereof. In some implementations, hardware can correspond to digital and/or analog circuitry arranged to carry out one or more portions of the computer-implemented method. In some implementations, hardware can correspond to physical processor 130 of FIG. 1. Additionally, software can correspond to software applications or programs that, when executed by the hardware, can cause the hardware to perform one or more tasks that carry out one or more portions of the computer-implemented method. In some implementations, software can correspond to one or more of modules 102 stored in memory 140 of FIG. 1.

The term “at least one processor,” as used herein, can generally refer to any type or form of hardware or combination of hardware and software. For example, and without limitation at least one processor can include a hardware-based processor, a software/firmware-based processor, hardware logic, and/or any combination thereof. Additional examples of at least one processor can include chiplets, monolithic die, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable processor. In this context, the at least one processor can correspond to the physical processor 130 of FIG. 1.

As illustrated in FIG. 2, at step 202 one or more of the systems described herein can detect failure. For example, failure detection module 104 can, at step 202, detect, by at least one processor, a failure of at least one communications channel of two or more communications channels of a data communications bus based at least in part on a header verification code included in a header of a first packet that was communicated over the two or more communications channels.

The term “data communications bus,” as used herein, can generally refer to a communication system that transfers data between components inside a computer or between computers. For example, a data communication bus can be digital or analog and can entail digital only protocols without the need for physical (PHY) and/or analog components. Stated differently, the expression “data communication bus” can cover all related hardware components (e.g., wire, optical fiber, etc.) and/or software, including communication protocols. Early computer buses were parallel electrical wires with multiple hardware connections, but the term is now used for any physical arrangement that provides the same logical function as a parallel electrical busbar. Modern computer buses can use both parallel and bit serial connections and can be wired in either a multidrop (electrical parallel) or daisy chain topology, or connected by switched hubs, as in the case of Universal Serial Bus (USB). Example types of communication buses and corresponding bus protocols can include Peripheral Component Interconnect Express (PCIe), Universal Chiplet Interconnect Express (UCIe), Bunch of Wires (BoW), USB, Controller Area Network (CAN), Local Interconnect Network (LIN), Ethernet, Transmission control Protocol (TCP), Internet Protocol (IP), Avionics Full-Duplex Switched Ethernet (AFDX), Ethernet Consist Network (ECN), etc.

The term “communications channel,” as used herein, can generally refer to one or more connections over which data can be transferred. For example, and without limitation, communication channels can be individual connections and/or groups of connections of a data communications bus. These connections can correspond, for example, to logical channels and/or physical channels. In this context, a set of communications channels of a data communication bus can include communication channels currently being used for exchange of data according to a current channel configuration (e.g., occupied lanes). Alternatively or additionally, a set of communications channels of a data communication bus can include communication channels that are active but that are not currently being used for exchange of data according to a current channel configuration (e.g., spare lanes).

The term “failure,” as used herein, can generally refer to technical and/or logistical issues with communication channel access or quality. For example, and without limitation, communication channel failure can be temporary (e.g., transient) or permanent. Example communication failures can include breakage of a physical medium (e.g., metal wire, optical fiber, etc.) used for data communication, an interruption of power to a physical medium used for data communication, malfunction of equipment employed to transfer data over a physical medium, etc.

The systems described herein can perform step 202 in a variety of ways. In one example, failure detection module 104 can, at step 202, detect failure to verify data of a previous packet that was communicated over the two or more communications channels. Alternatively or additionally, failure detection module 104 can, at step 202, detect failure to verify a previous header of the previous packet that was communicated over the two or more communications channels. In some of these examples, failure detection module 104 can, at step 202, carry out one or more procedures in a data reception mode of operation. Additionally or alternatively, failure detection module 104 can, at step 202, carry out one or more procedures in a data transmission mode of operation.

The term “packet,” as used herein, can generally refer to a block of data transmitted and/or received over a communications medium. For example, and without limitations, packet can refer to a small segment of a larger message. Often, these packets can be recombined by a computing device that receives them. Example types of packets can include flow control units (FLITs), which can correspond to packets used in communication and that can correspond to pieces of larger packets on which higher layer protocols can operate.

The term “subsequent packet,” as used herein, can generally refer to a packet exchanged over a data communication bus at later point in time compared to a previous packet. For example, and without limitation, a subsequent packet can be transmitted and/or received immediately after a subsequent packet or at any time later than the previous packet. Stated differently, previous and subsequent packets can be, but are not necessarily, adjacent to one another in a stream of communication. In this context, a subsequent packet can correspond to a retransmission of a previous packet, a retransmission of a portion of a previous packet, a transmission of an entirely different packet, etc.

The term “header,” as used herein, can generally refer to supplemental data placed at a beginning of a block of data being stored or transmitted. For example, and without limitation, the term header can refer to a single packet header, multiple packet headers (e.g., hierarchical packet headers), and/or any form of redundancy used in a given communication protocol.

The term “header verification code,” as used herein, can generally refer to an error correction code that is generated from a header of a packet but not a payload of the packet. For example, and without limitation, an error correction code can correspond to a cyclic redundancy check (CRC) code, a checksum, a block code (e.g., Reed-Solomon, Golay, BCH, multidimensional parity, hamming, single parity check (PC), low-density parity-check (LDPC), etc.), a convolutional code (e.g., Viterbi code, turbo code, systematic code, non-systematic code, recursive code, non-recursive code, punctured code, quantum code, etc.), etc.

In the data reception mode of operation, failure detection module 104 can, at step 202, extract information from a header of a packet received over two or more communications channels of a data communications bus. Example types of information that can be extracted from the header in step 202 can include an indication of one or more locations and one or more characteristics of the one or more parts omitted from a payload, an additional indication of a length of the packet, and/or a header verification code generated from the header but not the payload. In some of these examples, failure detection module 104 can, at step 202, attempt to verify a header and/or payload of a packet and fail to do so. Such attempts can be based on error correction codes or other types of verification information generated from the header and/or payload of the packet and extracted from the header and/or payload of the packet. For example, failure detection module 104 can, at step 202, attempt and fail to verify the header of the packet based on verification information extracted from the header of the packet and generated based on the header of the packet but not the payload of the packet. Alternatively or additionally, failure detection module 104 can, at step 202, extract, by the at least one processor, a payload of the packet based on information extracted from the header of the packet. In some of these examples, failure detection module 104 can, at step 202, extract, by the at least one processor, verification information from the payload of the packet that is generated based on at least the payload of the packet. In some of these examples, failure detection module 104 can, at step 202, attempt and fail to verify the payload of the packet based on the verification information extracted from the payload of the packet.

In the data transmission mode of operation, failure detection module 104 can, at step 202, receive a non-acknowledgement and/or fail to receive an acknowledgement indicating verification of a header and/or payload of the previous packet. In some of these examples, failure detection module 104 can, at step 202, receive a non-acknowledgement and/or fail to receive an acknowledgement over one or more of the data communications channels. Alternatively or additionally, failure detection module 104 can, at step 202, receive a non-acknowledgement and/or fail to receive an acknowledgement over one or more side channels, such as a dedicated control channel and/or a shared channel.

At step 204 one or more of the systems described herein can perform data communication. For example, data communication module 106 can, at step 204, perform data communication of a second packet over a subset of the two or more communications channels that excludes the at least one communications channel based on the failure of the at least one communications channel.

The term “data communication,” as used herein, can generally refer to the act of sending and/or receiving data. For example, and without limitation, data communication can refer to the exchange of data between two or more connected devices capable of sending and receiving data over a communications medium.

The term “payload,” as used herein, can generally refer to carrying capacity of a packet. For example, and without limitation, a payload can correspond to a portion of a packet that contains data intended for reassembly into a message (e.g., larger packets, media content, control commands, etc.). In this context, the payload can refer to a region of packet data that is distinct from one or more other packet regions, such as a header of the packet that can provide information about the packet. Regions that provide information about the payload, such as error correction codes (CRCs), can be appended to the payload and variously referred to as part of the payload or distinct from the payload. The present disclosure refers to extracting this type of information from the payload because it is often appended to the payload. However, such extraction can refer to extracting information about the payload from any portion of the packet.

The systems described herein can perform step 204 in a variety of ways. In one example, data communication module 106 can, at step 204, carry out one or more procedures in a data transmission mode of operation. Additionally or alternatively, data communication module 106 can, at step 204, carry out one or more procedures in a data reception mode of operation.

In the data transmission mode of operation, data communication module 106 can, at step 204, exclude from the subset of the two or more communications channels, in response to detecting a failure to verify the header of the packet based on the header verification code, a particular communication channel over which communication of the header of the packet occurred. In some of these examples, data communication module 106 can, at step 204, include in a header of the second packet a second header verification code generated from a header of the second packet but not a payload of the second packet, and dynamically reallocating the header of the second packet to a preset location among the two or more communications channels. In some of these examples, data communication module 106 can, at step 204, perform the data communication by including in a header of the second packet a second header verification code generated from a header of the second packet but not a payload of the second packet, and dynamically reallocating the header of the second packet to a preset location among the two or more communications channels. In additional or alternative examples, data communication module 106 can, at step 204, perform the data communication by excluding from the subset of the two or more communications channels, in response to detecting verification of the header of the packet based on the header verification code and detecting failure to verify a payload of the packet, a particular communication channel over which communication of at least part of the payload of the packet occurred. In some of these examples, data communication module 106 can, at step 204, perform the data communication by performing, in response to detecting verification of a header of the second packet and verification of a payload of the second packet, data communication of a third packet over the subset of the two or more communications channels. In additional or alternative examples, data communication module 106 can, at step 204, provision one or more spare lanes including one or more unallocated communications channels of the two or more communications channels and allocate at least one of the one or more unallocated communications channels to the subset of the two or more communications channels. Alternatively or additionally, data communication module 106 can, at step 204, perform the data communication by omitting from a payload of the second packet one or more parts of a payload of the packet, wherein the one or more parts omitted from the payload of the second packet correspond to one or more communication channels excluded from the subset of the two or more communications channels. In some of these examples, data communication module 106 can, at step 204, include in a header of the second packet an indication of the one or more parts omitted from the payload of the second packet, an additional indication of a length of the second packet, and/or a second header verification code generated from the header of the second packet but not the payload of the second packet. In some of these examples, data communication module 106 can, at step 204, include in the second packet a packet verification code generated from at least the payload of the second packet. In some examples, data communication module 106 can, at step 204, transmit data omitted from the packet over a side channel, such as a shared channel. In some implementations, data communication module 106 can, at step 204, restrict the type of information transmitted over the subset of communications channels to ensure that higher priority information (e.g., messages needed for safe vehicle operation) is transferred over the bus without competing for bandwidth with lower priority information (e.g., media content).

In the data reception mode of operation, data communication module 106 can, at step 204, send a non-acknowledgement and/or refrain from sending an acknowledgement indicating verification of a header and/or payload of the packet. In some of these examples, data communication module 106 can, at step 204, send a non-acknowledgement and/or refrain from sending an acknowledgement over one or more of the data communications channels. Alternatively or additionally, data communication module 106 can, at step 204, send the non-acknowledgement and/or refrain from sending the acknowledgement over one or more side channels, such as a dedicated control channel and/or a shared channel. In some examples, data communication module 106 can, at step 204, receive the second packet over the subset of the two or more communications channels. In some of these examples, data communication module 106 can, at step 204, receive data omitted from the second packet over a side channel, such as a shared channel.

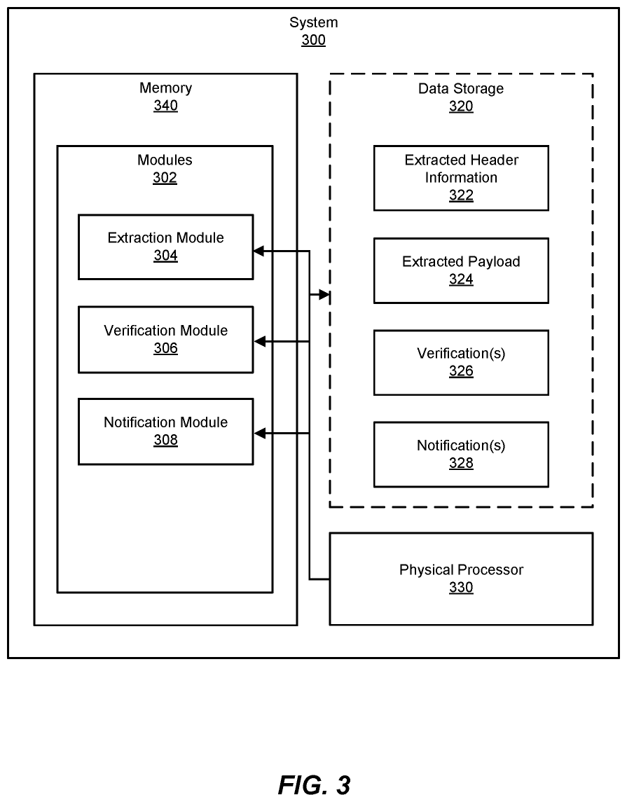

FIG. 3 is a block diagram of an example system 300 for performing data communications over a data communications bus. As illustrated in this figure, example system 300 can include one or more modules 302 for performing one or more tasks. As will be explained in greater detail below, modules 302 can include an extraction module 304, a verification module 306, and a notification module 308. Although illustrated as separate elements, one or more of modules 302 in FIG. 3 can represent portions of a single module or application.

In certain implementations, one or more of modules 302 in FIG. 3 can represent one or more software applications or programs that, when executed by a computing device, can cause the computing device to perform one or more tasks. For example, and as will be described in greater detail below, one or more of modules 302 can represent modules stored and configured to run on one or more computing devices. One or more of modules 302 in FIG. 3 can also represent all or portions of one or more special-purpose computers configured to perform one or more tasks.

As illustrated in FIG. 3, example system 300 can also include one or more memory devices, such as memory 340. Memory 340 generally represents any type or form of volatile or non-volatile storage device or medium capable of storing data and/or computer-readable instructions. In one example, memory 340 can store, load, and/or maintain one or more of modules 302. Examples of memory 340 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 3, example system 300 can also include one or more physical processors, such as physical processor 330. Physical processor 330 generally represents any type or form of hardware-implemented processing unit capable of interpreting and/or executing computer-readable instructions. In one example, physical processor 330 can access and/or modify one or more of modules 302 stored in memory 340. Additionally or alternatively, physical processor 330 can execute one or more of modules 302 to facilitate performing data communications over a data communications bus. Examples of physical processor 330 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 3, example system 300 can also include one or more instances of stored data, such as data storage 320. Data storage 320 generally represents any type or form of stored data, however stored (e.g., signal line transmissions, bit registers, flip flops, software in rewritable memory, configurable hardware states, combinations thereof, etc.). In one example, data storage 320 includes databases, spreadsheets, tables, lists, matrices, trees, or any other type of data structure. Examples of data storage 320 include, without limitation, extracted header information 322, extracted payload 324, verification(s) 326, and/or notification(s) 328.

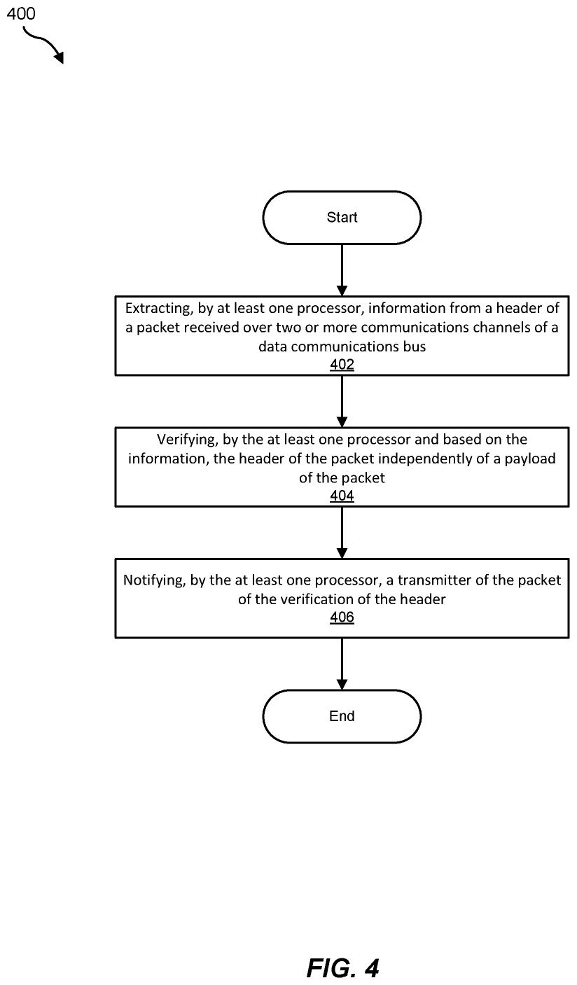

FIG. 4 is a flow diagram of an example computer-implemented method 400 for performing data communications over a data communications bus. The steps shown in FIG. 4 can be performed by any suitable computer-executable code and/or computing system. In one example, each of the steps shown in FIG. 4 can represent an algorithm whose structure includes and/or is represented by multiple sub-steps, examples of which will be provided in greater detail below.

As illustrated in FIG. 4, at step 402 one or more of the systems described herein can extract information. For example, extraction module 304 can, at step 402, extract information from a header of a packet received over two or more communications channels of a data communications bus.

The systems described herein can perform step 402 in a variety of ways. In one example, extraction module 304 can, at step 402, extract from a header of a received packet a header verification code generated from the header but not the payload of the packet. Alternatively or additionally, extraction module 304 can, at step 402, extract from the packet header an indication of a length of the packet. Alternatively or additionally, extraction module 304 can, at step 402, extract from the packet header an indication of one or more locations and/or one or more characteristics of one or more parts omitted (e.g., zero or more parts, zero or more communication channels, etc.) from the payload of the packet. In some implementations, extraction module 304 can, at step 402, further extract a payload of the packet based on header information such as an indication of a length of the packet and/or an indication of one or more locations and/or one or more characteristics of one or more parts omitted (e.g., zero or more parts, zero or more communication channels, etc.) from the payload of the packet.

At step 404 one or more of the systems described herein can perform verification. For example, verification module 306 can, at step 404, verify the header of the packet independently of a payload of the packet.

The systems described herein can perform step 404 in a variety of ways. In one example, verification module 306 can, at step 404, verify the header using a header verification code generated from the header but not the payload of the packet. In some of these examples, the header verification code can correspond to an error correction code generated from one or more parts of the header. In some implementations, the one or more parts of the header from which the header verification code is generated can exclude the header verification code as it was not yet generated and included in the header at a time of generation of the header verification code. In some implementations, verification module 306 can, at step 404, further verify the payload of the packet. In some of these implementations, extraction module 304 can, at step 402, extract the indication of the length of the packet and/or the indication of the one or more locations and/or the one or more characteristics of the one or more parts omitted from the payload, and further extract the payload all in response to verification of the header. In some implementations, verification module 306 can, at step 404, further verify the payload of the packet in response to verification of the header.

At step 406 one or more of the systems described herein can perform notification. For example, notification module 308 can, at step 406, notify a transmitter of the packet of the verification of the header.

The systems described herein can perform step 406 in a variety of ways. In one example, notification module 308 can, at step 406, send an acknowledgement indicating verification of the header of the packet. In some of these examples, notification module 308 can, at step 406, send an acknowledgement over one or more of the data communications channels. Alternatively or additionally, notification module 308 can, at step 406, send the acknowledgement over one or more side channels, such as a dedicated control channel and/or a shared channel. In some implementations, notification module 308 can, at step 406, send an acknowledgement indicating verification of the payload of the packet. In some of these examples, notification module 308 can, at step 406, send an acknowledgement over one or more of the data communications channels. Alternatively or additionally, notification module 308 can, at step 406, send the acknowledgement over one or more side channels, such as a dedicated control channel and/or a shared channel.

In some implementations, the method 200 of FIG. 2 and/or the method 400 of FIG. 4, and various implementations thereof detailed below with reference to FIGS. 5A-9, can be applied separately to a transmitter and a receiver of a particular device. For example, transmitter and receiver behavior in a point to point link can be readily apparent and thus can be applied to a channel from a first device transmitting to a second device separately from application to a channel from the second device transmitting to the first device. However, when a communication bus is shared among multiple devices, then the transmitter and receiver failure and resiliency repair can be less apparent.

When a communication bus is shared among multiple devices, the failure detection and resiliency repair techniques disclosed herein can be applied individually between pairs of devices that can communicate over the shared communication bus. For example, when a transmitter of a first device is faulty, then any device that receives a packet form the first device can signal a failure, triggering the first device to systematically reduce and/or modify (e.g., utilize spare channels) the transmission channels for any packet that it sends. However, when a receiver of a second device is faulty, then any device that transmits a packet to the second device only needs to reduce and/or modify (e.g., utilize spare channels) its transmission channels when transmitting to the second device, and not when transmitting to other devices.

Moreover, the fault detection and resiliency repair techniques disclosed

herein can be applied asymmetrically to two or more devices based on a communication direction between the two or more devices. For example, a first device transmitting to a second device can enact failure detection and resiliency repair. However, the second device may detect no faults or a different set of channel faults when transmitting to the first device, and thus forego or differently enact failure detection and resiliency repair. Thus, the failure detection and resiliency repair can be implemented in a bi-directional manner.

The method 200 of FIG. 2 and/or the method 400 of FIG. 4, and various implementations thereof detailed below with reference to FIGS. 5A-9, can be applicable to various levels of systems. For example, and without limitations, the failure detection and resiliency repair techniques disclosed herein can be applied at a data center level connecting racks of servers together, at a platform board level connecting packaged devices together, within a package connecting chiplets together, and/or on a single monolithic design connecting functional units to one another with on-chip buses.

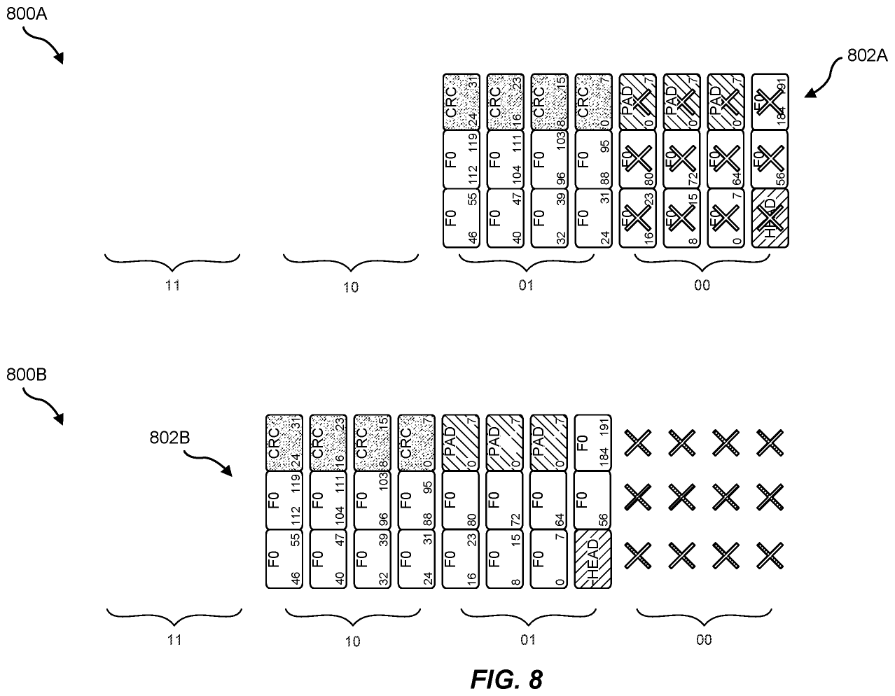

The method 200 of FIG. 2 and/or the method 400 of FIG. 4, and various implementations thereof detailed below with reference to FIGS. 5A-9, can be applied in various ways. For example, in some cases, and as later detailed herein with reference to FIG. 8, the failure detection and resiliency repair techniques disclosed herein can be applied by swapping one or more faulty communication channels with two or more communications channels corresponding to spare lanes. Alternatively or additionally, the failure detection and resiliency repair techniques disclosed herein can implement a fault model that defines exclusion parameters. For example, the fault model can determine a number and pattern of excluded lanes based on fault statistics. Alternatively or additionally, the failure detection and resiliency repair techniques disclosed herein can attempt to reclaim communications channels. For example, in the event the failure is transient, an attempt can be made to retest and reclaim the communications channels that were faulty. In another example, an attempt can be made to maximize a number of used communications channels after resiliency repair has proven successful. For example, after reducing from sixteen communications channels to eight communications channels, one or more (e.g., four) of the unused communications channels can be tested and added to the subset of communications channels if they are not faulty, thus increasing the number of communications in the subset (e.g., from eight to twelve).

As illustrated in FIG. 5A, an example system 500 for performing data communications over a data communications bus can include physical communication channels 508, logical communication channels 504, and devices 506A and 506B (e.g., peripheral devices, internal devices, I/O devices, data communications bus controllers, combinations thereof, etc.). For example, physical communication channels 508 can correspond to a physical layer 502 (PHY) associated with physical connections between devices 506A and 506B and/or a bus controller. Additionally, logical communication channels 504 can define partitions for data transferred over the physical layer 502. In this context, the logical communication channels 504 can be divided into control channels and traffic (e.g., data only and/or shared data and control) channels for different peripheral devices. Specifics of these divisions can vary by data communication bus protocol (e.g., PCIe, USB, CAN, LIN, Ethernet, TCP, IP, AFDX, ECN, etc.).

As shown in FIG. 5A, the example system 500 can include various additional components. For example, system 500 can include digital lanes 503 between devices (e.g., devices 506A and/or 506B) and logical communication channels 504. In some implementations, digital lanes 503 can correspond to communication channels in physical interface for PCI express (PIPE). Additionally, system 500 can include digital lanes 505 between logical communication channels 504 and physical layer 502. In some implementations, physical communication channels 508 can include analog communication channels associated with the physical connection between devices.

The systems and methods described herein can be implemented in a peripheral device and/or a bus controller and can encompass communication between the peripheral device and the bus controller and/or between peripheral devices, either directly or through a bus controller. Likewise, communication channel failure can occur with respect to logical channels and/or physical channels, with the latter case impacting communication between all devices transferring messages via those physical channels. Thus, when a device, such as a bus controller, observes same or similar communication channel failures for communicating with one or multiple peripheral devices (e.g., a threshold number of devices) and finds a subset of communication channels (e.g., channel configuration) that achieves successful communication, the bus controller can proactively begin using a same or similar subset of communication channels for communication with other peripheral devices.

As illustrated in FIG. 5B, example communications channels 550A and 550B of a data communications bus can correspond to sixteen communication channels that can be organized into a number (e.g., sixteen) of eight bit octets (e.g., bytes) exchanged over four parts 11, 10, 01, and 00 of a set of communications channels of a data communication bus. The illustrated implementation of a sixteen eight-bit octets provides an example of lanes between “LOGIC” and “PHY.” For a sixteen channel bus, each of these parts 11, 10, 01, and 00 can include four communication channels. In some implementations, the four parts 11, 10, 01, and 00 can serve as preset locations (e.g., for header reallocation) by determining individual parts as faulty or not faulty. For example, if a header is not verified, then an entire part including a communication channel over which the header was transmitted can be determined as faulty. In other implementations, lanes can have different widths (e.g., not eight bits and thus not octets) and/or different numbers of lanes (e.g., not sixteen lanes). Moreover, the number of parts into which the set of communications channels are divided can vary and/or be dynamically changed in other implementations. For example, dynamically determining the number of parts can entail subdividing a set of parts into more, smaller parts in response to a determination of all of the parts of the set as being faulty.

The example communications channels 550A and 550B can have features related to the digital lanes 503, the digital lanes 505, the logical communication channels 504, the physical layer 502, and/or the physical communication channels 508 of FIG. 5A. For example, and entire width 555 of the digital lanes 503 and/or digital lanes 505 is shown with reference to FIG. 5A. In some implementations, the sum of all channels corresponding to digital lanes 503 and the sum of all channels corresponding digital lanes 505 can be the same. In other implementations, these sums can differ. In the example in FIG. 5B, all of the channels corresponding to the entire width 555 of the digital lanes are divided logically into elements 553 having widths of eight bits (e.g., octets). Additionally, the entire width 555 of the digital lanes is shown as sixteen octets. Also, elements 556 correspond to elements 553 that are faulty, either partially or entirely. A packet header 552A can occupy one or more of the elements 553 that are not faulty. Thus, the packet header 552A is not faulty because it does not fall on faulty lanes. In contrast, a packet header 552B is faulty because it falls on faulty lanes. Finally, elements 554, into which the entire bus of width 55 is divided, is shown as being divided in to the four parts 11, 10, 01, and 00 which can be perceived as containing either fully functional or entirely faulty lanes. However, in other implementations the entire width 55 can be divided into any number of parts and/or the number of parts can be dynamically changeable.

Example communications channels 550A demonstrate channel failure for part 01, with the packet header 552A falling on part 00. Thus, a recipient device can successfully receive and verify the packet header 552A, extract the payload, but unsuccessfully verify the payload based on an error correction code, such as a cyclic redundancy check (CRC) code appended to the payload in part 11. Example communications channels 550B demonstrate channel failure for both part 00 and part 01, with the packet header 552B falling on part 00. Thus, a recipient device can neither successfully receive and verify the packet header 552B nor extract and verify the payload.

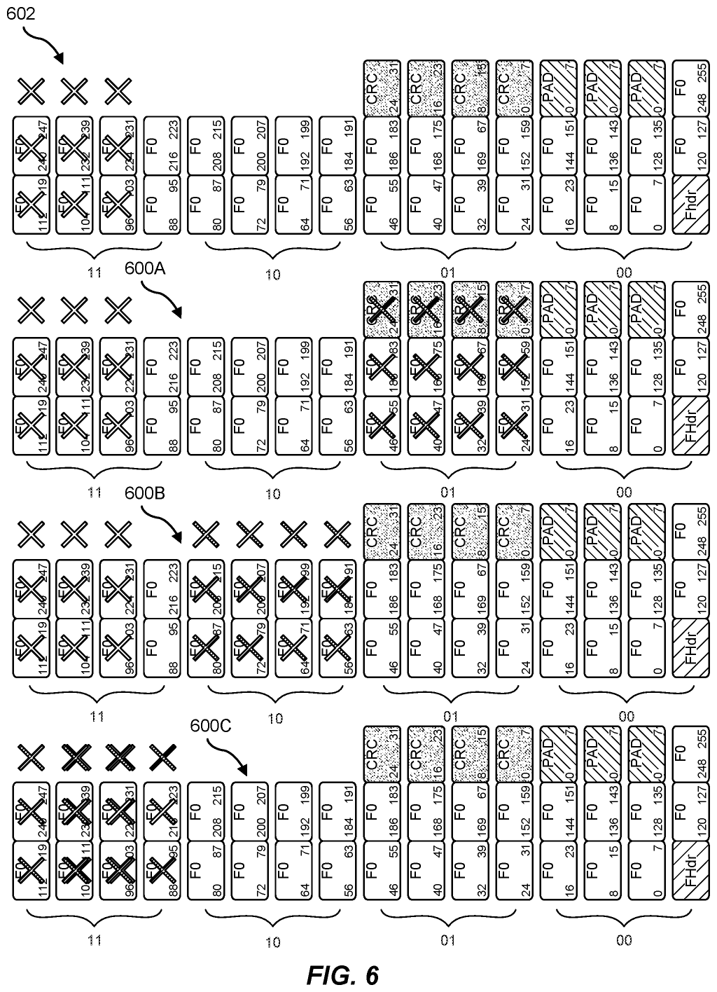

As illustrated in FIG. 6, example subsets 600A, 600B, and 600C of communications channels 602 of a data communications bus can experience failure of three channels of part 11. In this case, the recipient device can verify the header of a first packet but not the payload of the first packet and notify a sender of the first packet accordingly. In response to the notification, the sender of the first packet can omit part 01 from a second packet (e.g., a subsequent packet after the first packet) which can contain the same or different payload contents as the first packet (e.g., a previous packet with respect to the second packet), thus communicating the second packet with a reduced payload and a header that contains appropriate header information as disclosed herein. Omitting part 01 from the second packet can correspond to using a subset 600A of communications channels mapped to parts 11, 10, and 00 as shown, and packet header information of the second packet can indicate that part 01 is omitted from and/or that parts 11, 10, and 00 are included in the second packet.

Upon receiving the second packet, the recipient device can verify the header of the packet but not the payload of the packet and notify a sender of the packet accordingly. In response to the notification, the sender of the second packet can omit part 10 instead of part 01 from a third packet (e.g., a subsequent packet after the second packet), which can contain the same or different payload contents as the second packet (e.g., a previous packet with respect to the third packet), thus communicating the third packet with a reduced payload and a header that contains appropriate header information as disclosed herein. Omitting part 10 instead of part 01 from the third packet can correspond to using a subset 600B of communications channels mapped to parts 11, 01, and 00 as shown, and packet header information of the third packet can indicate that part 10 is omitted from and/or that parts 11, 01, and 00 are included in the third packet.

Upon receiving the third packet, the recipient device can verify the header of the packet but not the payload of the packet and notify a sender of the packet accordingly. In response to the notification, the sender of the third packet can omit part 11 instead of part 10 from a fourth packet (e.g., a subsequent packet after the third packet), which can contain the same or different payload contents as the third packet (e.g., a previous packet with respect to the fourth packet), thus communicating the fourth packet with a reduced payload and a header that contains appropriate header information as disclosed herein. Omitting part 11 instead of part 10 from the fourth packet can correspond to using a subset 600C of communications channels mapped to parts 10, 01, and 00 as shown, and packet header information of the fourth packet can indicate that part 11 is omitted from and/or that parts 10, 01, and 00 are included in the fourth packet.

Upon receiving the fourth packet, the recipient device can verify the header of the packet and also the payload of the packet and notify a sender of the packet accordingly. In response to these notifications, the sender of the fourth packet can continue communicating with the recipient device using the subset 600C that omits part 11. The sender of the fourth packet and subsequent packets additionally can restrict the type of information transmitted over the subset 600C of communications channels to ensure that higher priority information (e.g., messages needed for safe vehicle operation) is transferred over the bus without competing for bandwidth with lower priority information (e.g., media content). In some implementations, the sender of the fourth packet and subsequent packets further can send data over a side channel, such as a shared channel, to improve data communication bandwidth and take advantage of control messaging bandwidth that can become available due to restriction of the type of information transmitted over the subset 600C of communications channels.

In other examples in which the data communications bus can experience failure of one or more channels of multiple communications channels on different parts, the sender can send subsequent packets that omit channels at a finer level of granularity (e.g., triplets of channels, pairs of channels, and/or individual channels). Alternatively or additionally, a bus controller or other computing device can restart the communications bus after a threshold number of on-the-fly communications resilience attempts have proven unsuccessful. Alternatively or additionally, a bus controller or other computing device can attempt on-the-fly communications resilience at finer levels of granularity after a threshold number of restarts have proven unsuccessful in reestablishing communications.

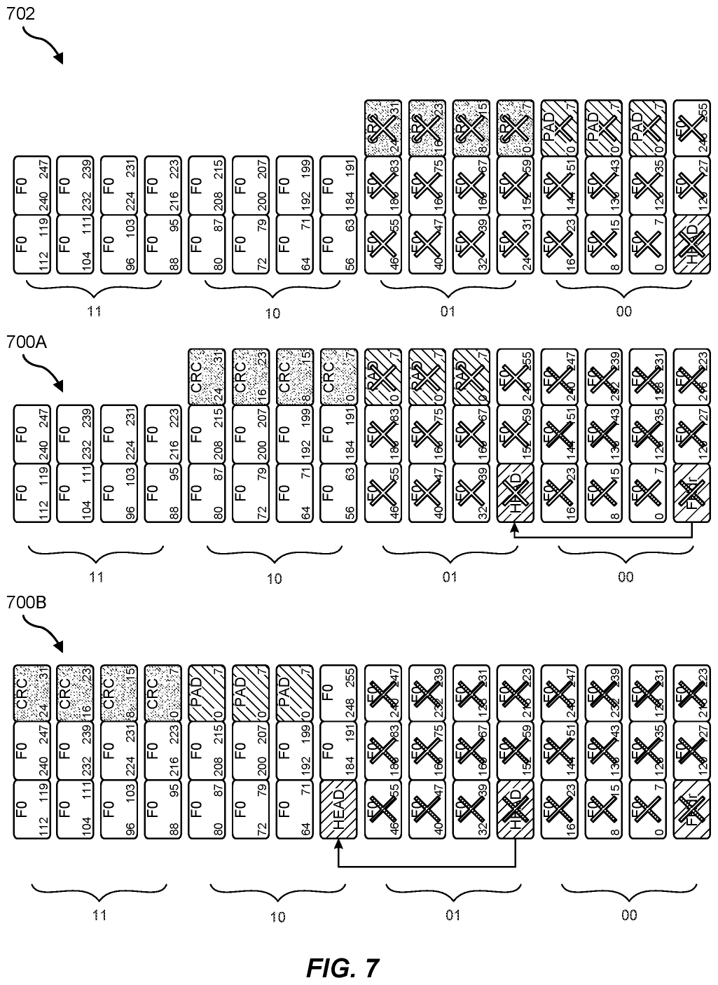

As illustrated in FIG. 7, example subsets 700A and 700B of communications channels 702 of a data communications bus can experience failure of eight channels of parts 01 and 00. A packet header can fall on faulty lanes of part 00, causing its header verification code (e.g., checksum CRC) not to match. In this case, the recipient device can neither verify the header of a first packet nor a payload of the first packet and either notify a sender of the first packet accordingly or refrain from sending a notification to the sender of the first packet. In response to the notification and/or lack thereof, the sender of the first packet can omit part 00 from a second packet (e.g., a subsequent packet after the first packet) which can contain the same or different payload contents as the first packet (e.g., a previous packet with respect to the second packet), thus communicating the second packet with a reduced payload and a header that is relocated to part 01 (e.g., the header is reallocated at one of one or more predetermined alternative offsets within the entire width 555 of FIG. 5B) and that contains appropriate header information as disclosed herein. Omitting part 00 from the second packet can correspond to using a subset 700A of communications channels mapped to parts 11, 10, and 01 as shown, and packet header information of the second packet can indicate that part 00 is omitted from the second packet and/or that parts 11, 10, and 01 are included in the second packet.

Upon receiving the second packet, the recipient device still can neither verify the header of the second packet nor a payload of the second packet and either notify the sender of the second packet accordingly or refrain from sending a notification to the sender of the second packet. In response to the notification and/or lack thereof, the sender of the second packet can omit parts 01 and 00 from a third packet (e.g., a subsequent packet after the second packet) which can contain the same or different payload contents as the second packet (e.g., a previous packet with respect to the second packet), thus communicating the second packet with a reduced payload and a header that is relocated to part 10 and that contains appropriate header information as disclosed herein. Omitting parts 01 and 00 from the third packet can correspond to using a subset 700B of communications channels mapped to parts 11 and 10 as shown, and packet header information of the third packet can indicate that parts 10 and 00 are omitted from the third packet and/or that parts 11 and 10 included in the third packet.

Upon receiving the third packet, the recipient device now can verify the header of the third packet and the payload of the third packet and notify the sender of the third packet accordingly. In response to the notification(s), the sender of the third packet can continue communicating with the recipient device using the subset 700B that omits parts 10 and 00. The sender of the third packet and subsequent packets additionally can restrict the type of information transmitted over the subset 700B of communications channels to ensure that higher priority information (e.g., messages needed for safe vehicle operation) is transferred over the bus without competing for bandwidth with lower priority information (e.g., media content). In some implementations, the sender of the third packet and subsequent packets further can send data over a side channel, such as a shared channel, to improve data communication bandwidth and take advantage of control messaging bandwidth that can become available due to restriction of the type of information transmitted over the subset 700B of communications channels.

In other examples in which the data communications bus can experience failure of multiple communications channels on different parts that are used for header relocation, the sender can send subsequent packets that relocate the header on different channels until one is found that at least results in successful header verification. Then, the sender can try other channel configurations using that header location with the payload distributed among different channels at finer levels of granularity until success is achieved or until a threshold number of unsuccessful on-the-fly communications resilience attempts have been made. Alternatively or additionally, a bus controller or other computing device can restart the communications bus after a threshold number of on-the-fly communications resilience attempts have proven unsuccessful. Alternatively or additionally, a bus controller or other computing device can attempt on-the-fly communications resilience at finer levels of granularity after a threshold number of restarts have proven unsuccessful in reestablishing communications.

As illustrated in FIG. 8, example sets 800A and 800B of communications channels of a data communications bus can include spare lanes that are active and form part of the two or more communications channels of the data communications bus over which a packet can be transmitted and/or received. For example, set 800A of communications channels can include parts 11 and 10 configured as spare lanes and parts 01 and 00 that form a subset of the communications channels over which a first packet 802A is transmitted and/or received. Upon experiencing failure of four channels of part 00, the recipient device can neither verify the header of a first packet 802A nor a payload of the first packet 802A. As a result, the recipient device can either notify a sender of the first packet 802A accordingly or refrain from sending a notification to the sender of the first packet 802A. In response to the notification and/or lack thereof, the sender of the first packet 802A can modify a second packet 802B (e.g., a subsequent packet after the first packet) which can contain the same or different payload contents as the first packet 802A (e.g., a previous packet with respect to the second packet) and communicate the second packet 802B over parts 10 and 01, thus using one or more of the spare lanes. A header of the second packet 802B can contain appropriate header information as disclosed herein. Modifying the second packet 802B can correspond to using a different subset of the communications channels, with the different subset being mapped to parts 10 and 01 as shown. Packet header information of the second packet 802B can indicate that parts 10 and 01 are included in the second packet 802B.

In other examples, spare lanes can be used even when a header of the first packet 802A is successfully received over channels of part 00. For example, if channels of part 01 experience failure instead of channels of part 00, the header may be verified but not the payload. In this scenario, the second packet 802B can be exchanged over a different subset of communication channels corresponding to parts 10 and 00. Alternatively, the second packet 802B can be exchanged over a different subset of communication channels corresponding to parts 11 and 10. Using spare lanes in the manner disclosed herein can avoid reduction of packet payload.

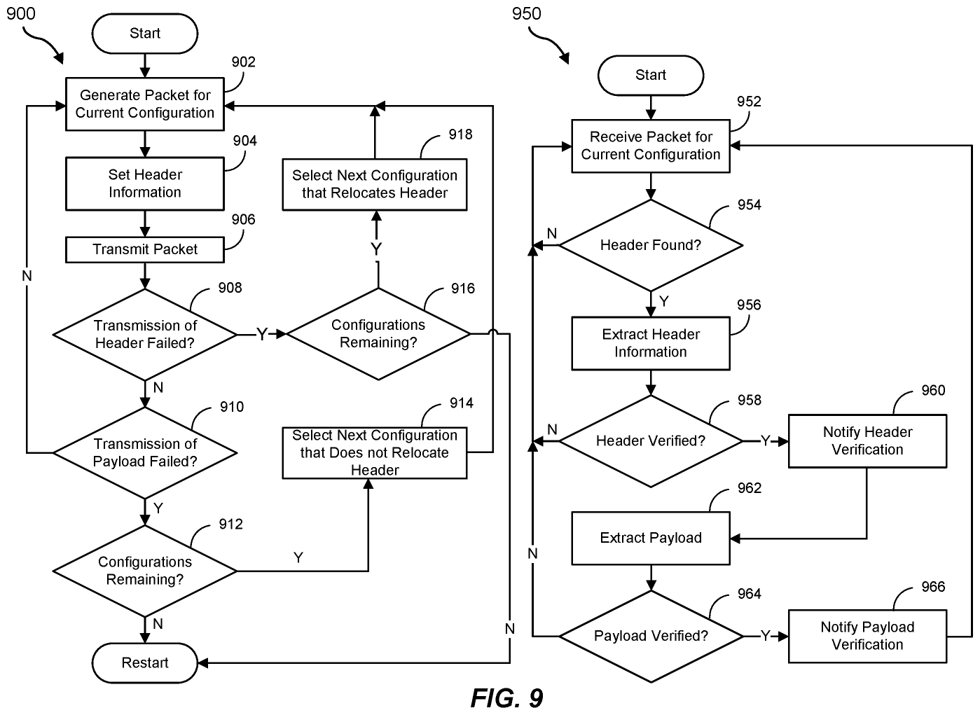

As illustrated in FIG. 9, example methods 900 and 950 for performing data communications over a data communications bus are shown. For example, method 900 can entail procedures that can be carried out by a computing device (e.g., bus controller and/or peripheral device) during a data transmission mode of operation. Additionally, method 950 can entail procedures that can be carried out by a computing device (e.g., bus controller and/or peripheral device) during a data reception mode of operation. Methods 900 and 950 can include one or combinations of procedures detailed herein with reference, for example, to FIG. 2, FIG. 4, FIG. 6, FIG. 7, and/or FIG. 8 and/or can be performed by systems detailed herein with reference, for example, to FIG. 1, FIG. 3, and/or FIG. 5A.

During the data transmission mode of operation, method 900 can, at step 902, include generating a packet for a current channel configuration. For example, on a first iteration of method 900, step 902 can, for example, generate a packet for an entire set of data communications channels of a data communications bus (e.g., a normal configuration). Then, at step 904, method 900 can include setting header information of the packet, such as an indication of the one or more parts omitted from a reduced payload (e.g., zero or more parts), an additional indication of a length of the packet, and/or a header verification code generated from the header but not the payload of the packet. Next, at step 906, method 900 can transmit the packet over the one or more communication channels according to the current channel configuration.

Following step 906, method 900 can, at step 908, determine that transmission of the header did not fail (e.g., based on an acknowledgment of the header received from a recipient of the packet). Finally, method 900 can, at step 910, determine that transmission of the payload of the packet did not fail (e.g., based on an acknowledgment of the payload received from the recipient of the packet). In this case, processing can return to step 902 for continued operation according to the current channel configuration.

In the event of a communications channel failure preventing successful payload transmission, however, method 900 can, at step 910, determine that transmission of the payload of the packet failed (e.g., based on a non-acknowledgment of the payload received from the recipient of the packet and/or failure to receive an acknowledgement of the payload). In this case, method 900 can, at step 912, determine that there are one or more other channel configurations remaining over which transmission has not yet been attempted and that do not relocate the header to a different channel. For example, method 900 can, at step 912, determine that a threshold number (e.g., greater than zero) of predetermined channel configurations and/or dynamically determined channel configurations remain that do not relocate the header and that have not yet been tried. Alternatively or additionally, method 900 can, at step 912, maintain a count (e.g., a number of transmission attempts with varied channel configurations, a time since failure detection, an amount of bandwidth potentially available with remaining channel configurations not yet attempted, etc.) and determine that there are one or more other channel configurations remaining by comparing the count to a predetermined an/or dynamically determined threshold condition (e.g., a threshold number of transmission attempts with varied channel configurations, a threshold amount of time since failure detection, a threshold amount of bandwidth, etc.).

In response to determining that there are one or more other channel configurations remaining at step 912, method 900 can, at step 914, select a next channel configuration that does not relocate the header to a different channel, and processing can return to step 902. Otherwise, in response to determining at step 916 that no more channel configurations remain that relocate the header, processing can end (e.g., in which case the bus can be subjected to a restart procedure).

In the event of a communications channel failure preventing successful header transmission, on the other hand, method 900 can, at step 908, determine that transmission of the header of the packet failed (e.g., based on a non-acknowledgment of the header received from the recipient of the packet and/or failure to receive an acknowledgement of the header). In this case, method 900 can, at step 912, determine that there are one or more other channel configurations remaining over which transmission has not yet been attempted and that relocate the header to a different communications channel. For example, method 900 can, at step 916, determine that a threshold number (e.g., greater than zero) of predetermined channel configurations and/or dynamically determined channel configurations remain that relocate the header but have not yet been tried. Alternatively or additionally, method 900 can, at step 916, maintain a count (e.g., a number of transmission attempts with varied channel configurations, a time since failure detection, an amount of bandwidth potentially available with remaining channel configurations not yet attempted, etc.) and determine that there are one or more other channel configurations remaining by comparing the count to a predetermined an/or dynamically determined threshold condition (e.g., a threshold number of transmission attempts with varied channel configurations, a threshold amount of time since failure detection, a threshold amount of bandwidth, etc.).

In response to determining that there are one or more other channel configurations remaining at step 916, method 900 can, at step 918, select a next channel configuration that relocates the header to a different channel, and processing can return to step 902. Otherwise, in response to determining at step 916 that no more channel configurations remain that relocate the header, processing can end (e.g., in which case the bus can be subjected to a restart procedure).

During the data reception mode of operation, method 950 can, at step 952, receive a packet for a current channel configuration. For example, method 950 can, at step 952, attempt to receive data on each and every communications channel of a data communications bus. Then, method 950 can, at step 954, determine that a header of the packet is found in data received at step 952. For example, method 950 can, at step 954, search for the header in any or all data received over the data communications bus.

In response to determining that the header is found at step 954, method 950 can, at step 956, extract information from the header. For example, method 950 can, at step 956, extract from the header a header verification code generated from the header but not the payload of the packet. Alternatively or additionally, method 950 can, at step 956, extract from the header an indication of a length of the packet. Alternatively or additionally, method 950 can, at step 956, extract from the header an indication of one or more parts omitted (e.g., zero or more parts, zero or more communication channels, etc.) from the payload of the packet.

Next, method 950 can, at step 958, determine that the header is verified based on at least part of the information extracted from the header at step 956. In response to determining that the header is verified at step 958, method 950 can, at step 960, notify a sender of the packet of the header verification. Then, method 950 can, at step 962, extract the payload of the packet from the data received at step 952. For example, method 950 can, at step 962, extract the payload based on at least part of the information extracted from the header at step 956. Next, method 950 can, at step 964, determine that the payload is verified based on a payload verification information (e.g., error correction code, CRC, etc.) extracted from the payload. In response to determining that the payload is verified at step 964, method 950 can, at step 966, notify a sender of the packet of the payload verification.

In the event of a communications channel failure preventing successful payload reception, however, method 950 can, at step 964, determine that the payload is not verified based on the payload verification information extracted from the payload. In response to determining that the payload is not verified at step 964, method 950 can, at step 964, return to step 952. In some implementations, method 950 can, at step 964, respond to determining that the header is not verified at step 964 by notifying the sender of the packet that the payload was not verified.

In the event of a communications channel failure preventing successful header reception, however, method 950 can, at step 958, determine that the header is not verified based on the header verification information extracted from the header. In response to determining that the header is not verified at step 958, method 950 can, at step 958, return to step 952. In some implementations, method 950 can, at step 958 respond to determining that the header is not verified at step 958, by notifying the sender of the packet that the header was not verified.

Likewise, method 950 can, at step 954, determine that the header was not found in the data received at step 952. In response to determining that the header was not found at step 954, method 950 can, at step 954, return to step 952. In some implementations, method 950 can, at step 954, respond to determining that the header was not found at step 954 by notifying the sender of the packet that the header was not found and/or not verified.

As set forth above, the disclosed systems and methods can perform data communications over a data communications bus. For example, by detecting a failure of at least one communications channel of two or more communications channels of a data communications bus based at least in part on a header verification code included in a header of a first packet that was communicated over the two or more communications channels and performing data communication of a second packet over a subset of the two or more communications channels that excludes the at least one communications channel based on the failure of the at least one communications channel, the disclosed systems and methods can achieve various benefits. Example benefits include on-the-fly restoration of failed communications channels, maximization of communication channels up-time, increased fault tolerance, achievement of qualification for safety-critical applications such as automotive requirements, achievement of affective handling of transient and/or permanent physical faults, and achievement of an enhanced resilience appraisal scale level.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 and/or system 300 in FIG. 3 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 and/or system 300 in FIG. 3 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 and/or system 300 in FIG. 3 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example system 100 in FIG. 1 and/or system 300 in FIG. 3 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device, comprising:
failure detection circuitry configured to detect a failure of at least one communications channel of two or more communications channels of a data communications bus based at least in part on a header verification code included in a header of a first packet that was communicated over the two or more communications channels; and
data communication circuitry to perform data communication of a second packet over a subset of the two or more communications channels that excludes the at least one communications channel based on the failure of the at least one communications channel.

2. The computing device of claim 1, wherein the data communication circuitry is configured to perform the data communication by:
excluding from the subset of the two or more communications channels, in response to detecting a failure to verify the header of the first packet based on the header verification code, a particular communication channel over which communication of the header of the first packet occurred.

3. The computing device of claim 2, wherein the data communication circuitry is configured to perform the data communication by:
including in a header of the second packet a second header verification code generated from a header of the second packet but not a payload of the second packet; and
dynamically reallocating the header of the second packet to a preset location among the two or more communications channels.

4. The computing device of claim 1, wherein the data communication circuitry is configured to perform the data communication by:
excluding from the subset of the two or more communications channels, in response to detecting verification of the header of the first packet based on the header verification code and detecting failure to verify a payload of the first packet, a particular communication channel over which communication of at least part of the payload of the first packet occurred.

5. The computing device of claim 4, wherein the data communication circuitry is configured to perform the data communication by:
performing, in response to detecting verification of a header of the second packet and verification of a payload of the second packet, data communication of a third packet over the subset of the two or more communications channels.

6. The computing device of claim 1, wherein the data communication circuitry is further configured to:
provision one or more spare lanes including one or more unallocated communications channels of the two or more communications channels; and
allocate at least one of the one or more unallocated communications channels to the subset of the two or more communications channels.

7. The computing device of claim 1, wherein the data communication circuitry is configured to perform the data communication by:
omitting from a payload of the second packet one or more parts of a payload of the first packet, wherein the one or more parts omitted from the payload of the second packet correspond to one or more communication channels excluded from the subset of the two or more communications channels;
including in a header of the second packet an indication of one or more locations of the one or more parts omitted from the payload of the second packet, an additional indication of a length of the second packet, and a second header verification code generated from the header of the second packet but not the payload of the second packet; and
including in the second packet a packet verification code generated from at least the payload of the second packet.

8. A system comprising:
a data communication bus including two or more communications channels;
a first device connected to the data communication bus and configured to detect a failure of at least one communications channel of the two or more communications channels based at least in part on a header verification code included in a header of a first packet that was communicated over the two or more communications channels; and
a second device connected to the data communication bus, wherein the first device is configured to perform data communication of a second packet to the second device over a subset of the two or more communications channels that excludes the at least one communications channel based on the failure of the at least one communications channel.

9. The system of claim 8, wherein the first device is configured to perform the data communication by:
excluding from the subset of the two or more communications channels, in response to detecting a failure to verify the header of the first packet based on the header verification code, a particular communication channel over which communication of the header of the first packet occurred.

10. The system of claim 9, wherein the first device is configured to perform the data communication by:
including in a header of the second packet a second header verification code generated from a header of the second packet but not a payload of the second packet; and
dynamically reallocating the header of the second packet to a preset location among the two or more communications channels.

11. The system of claim 8, wherein the first device is configured to perform the data communication by:
excluding from the subset of the two or more communications channels, in response to detecting verification of the header of the first packet based on the header verification code and detecting failure to verify a payload of the first packet, a particular communication channel over which communication of at least part of the payload of the first packet occurred.

12. The system of claim 11, wherein the first device is configured to perform the data communication by:
performing, in response to detecting verification of a header of the second packet and verification of a payload of the second packet, data communication of an third packet over the subset of the two or more communications channels.

13. The system of claim 8, wherein the first device is further configured to:
provision one or more spare lanes including one or more unallocated communications channels of the two or more communications channels; and
allocate at least one of the one or more unallocated communications channels to the subset of the two or more communications channels.

14. The system of claim 8, wherein the first device is configured to perform the data communication by:
omitting from a payload of the second packet one or more parts of a payload of the first packet, wherein the one or more parts omitted from the payload of the second packet correspond to one or more communication channels excluded from the subset of the two or more communications channels;
including in a header of the second packet an indication of one or more locations of the one or more parts omitted from the payload of the second packet, an additional indication of a length of the second packet, and a second header verification code generated from the header of the second packet but not the payload of the second packet; and
including in the second packet a packet verification code generated from at least the payload of the second packet.

15. A computer-implemented method comprising:
detecting, by at least one processor, a failure of at least one communications channel of two or more communications channels of a data communications bus based at least in part on a header verification code included in a header of a first packet that was communicated over the two or more communications channels; and
performing, by the at least one processor, data communication of a second packet over a subset of the two or more communications channels that excludes the at least one communications channel based on the failure of the at least one communications channel.

16. The computer-implemented method of claim 15, wherein performing the data communication further includes:
excluding from the subset of the two or more communications channels, in response to detecting a failure to verify the header of the first packet based on the header verification code, a particular communication channel over which communication of the header of the first packet occurred.

17. The computer-implemented method of claim 16, wherein performing the data communication further includes:
including in a header of the second packet a second header verification code generated from a header of the second packet but not a payload of the second packet; and
dynamically reallocating the header of the second packet to a preset location among the two or more communications channels.

18. The computer-implemented method of claim 15, wherein performing the data communication further includes:
excluding from the subset of the two or more communications channels, in response to detecting verification of the header of the first packet based on the header verification code and detecting failure to verify a payload of the first packet, a particular communication channel over which communication of at least part of the payload of the first packet occurred.

19. The computer-implemented method of claim 15, wherein performing the data communication further includes:
provisioning one or more spare lanes including one or more unallocated communications channels of the two or more communications channels; and
allocating at least one of the one or more unallocated communications channels to the subset of the two or more communications channels.

20. The computer-implemented method of claim 15, wherein performing the data communication includes:
omitting from a payload of the second packet one or more parts of a payload of the first packet, wherein the one or more parts omitted from the payload of the second packet correspond to one or more communication channels excluded from the subset of the two or more communications channels;
including in a header of the second packet an indication of one or more locations of the one or more parts omitted from the payload of the second packet, an additional indication of a length of the second packet, and a second header verification code generated from the header of the second packet but not the payload of the second packet; and
including in the second packet a packet verification code generated from at least the payload of the second packet.
